(19) United States
(12) Patent Application Publication
(10) Pub. No.: US 2023/0002677 A1
(43) Pub. Date: Jan. 5, 2023

(54) LIQUID WASTE DECOMPOSER

(71) Applicant: Krishan CHANDRA, Lucknow (IN)

(72) Inventor: Krishan CHANDRA, Lucknow (IN)

(21) Appl. No.: 17/855,582

(22) Filed: Jun. 30, 2022

(30) Foreign Application Priority Data
Jul. 2, 2021 (IN) 202111029978

(51) Int. Cl. C09K 17/14; C05F 11/08

(52) U.S. Cl. CPC C09K 17/14; C05F 11/08

(57) ABSTRACT

The present disclosure relates to a composition for improve the soil fertility and it's application as irrigation which decomposes plant roots, undecomposed material thereby increase the organic carbon as well all nutrient to the plant. The agricultural composition comprising jaggery and liquid waste decompose. The agricultural composition of the present disclosure can be used for improving soil condition and promoting plant growth.

### FIELD OF THE INVENTION

The invention relates to the technical field of decomposer, in particular to a composition for soil conditioning and an application thereof.

### BACKGROUND OF THE INVENTION

The background information herein below relates to the present disclosure but is not necessarily prior art.

Plant growth and crop productivity is dependent mainly on the physical conditions of soil. Characteristics of good soil are high water holding capacity, adequate minerals such as boron, chlorine, cobalt, copper, iron, manganese, magnesium, molybdenum, sulphur and zinc for promoting plant growth and it (the soil) being well-drained. The soil characteristics can be improved through the use of good management practices. The soil characteristics can also be improved using microorganisms containing the potential to decompose soil organic matter, which in turn promotes plant growth by producing metabolites, increasing water retention capacity of the soil and also improving the physical condition of the soil. The improvement in soil texture and thereby the overall soil physical property is termed as soil conditioning.

The organic contents of soils are reduced due to the extensive use of chemical fertilizers and repeated farming which leads to hardening of the soil. Further, soil particles become compact and are not able to retain nutrients and moisture due to repeated and overuse of chemical fertilizers. Due to this, higher amounts of chemical fertilizer are required to supplement mineral ions and macro nutrients which are gradually lost from the soil. Extensive use of chemical fertilizers is a major cause of imbalance in the micro and macro nutrients in the soil and has deteriorated soil health, which ultimately results in low productivity and stagnancy in agriculture growth. For optimum plant growth, nutrients must be available in sufficient and balanced quantities. Excessive and exclusive dependence on nitrogenous and phosphate fertilizers can be very harmful to the soil. As a result, overall agricultural productivity gradually declines.

The constant assault on land (soil) by agricultural and horticultural chemicals cause imbalance in the amount of essential nutrients in the soil. Thus, the soil is rendered unsuitable for sustained farming and at times the soil denatures to such an extent that normal levels of plant life cannot be supported.

At present, waste decomposer are available in solid form but their shelf life is limited to 3 years or less than 3 years. Moreover, the efficacy lose in long storage as mother culture, and the culture dry in one year of storage in normal temperature. Furthermore, a number of other substances in the form of soil conditioners are available which claims for improving soil physical properties are very much available commercially in the market. However, these substances e.g. soil conditioners have limited activity and are not effective on all types of soil and/or crops/plants.

Therefore, there is felt a need for an agricultural composition that mitigates the aforementioned drawbacks.

### OBJECTS OF THE INVENTION

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a semi liquid or gel form which has more than 5 years shelf life, survive in normal outside temperature, and also capable of improving soil condition and in turn promote plant growth.

Still another object of the present disclosure is to provide an agricultural composition comprising an additive for soil conditioning and plant growth regulator for promoting plant growth.

Other objects and advantages of the present disclosure will be more apparent from the following description, which is not intended to limit the scope of present disclosure.

### SUMMARY OF THE INVENTION

An aspect of the present invention is to address at least the above-mentioned problems and/or disadvantages and to provide at least the advantages described below.

Accordingly, in one aspect of the present invention is an agricultural composition to improve the soil fertility. In one embodiment, the composition including 1% of water-retaining gel, 40% of beneficial bacteria like cellulose, lignin, pectin and lipids decomposer 40%, raw materials including liquid waste decompose and 2-10% of Jaggery. The composition decomposes plant roots and undecomposed materials thereby increasing the organic carbon as well all nutrient to the plant.

In another aspect of the present invention is a process for preparing an agricultural composition. The process including adding of 100 litres of water mixing with 1 kg of jaggery, beneficial bacteria and a considerable amount of raw materials including liquid waste decompose, and kept for 5 days in normal outside temperature to self-multiple.

Other aspects, advantages, and salient features of the invention will become apparent to those skilled in the art from the following detailed description, which, taken in conjunction with the annexed drawings, discloses exemplary embodiments of the invention.

### DETAILED DESCRIPTION OF THE INVENTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Though the use of chemical fertilizers and insecticides has increased agricultural productivity for a while, there has been a stagnation due to the use of extensive chemical fertilizers, which deteriorates soil health resulting in low productivity of agriculture produce. To improve agricultural productivity, farmers use chemicals to fertilize plants and to fight pests and diseases. However, most of these chemicals destroy beneficial soil microorganisms and damage a plant's natural ability to fend off pests and diseases. Further, chemical fertilizers can build up in the soil and eventually reduce the overall productivity of the soil, and the plants become weaker and weaker in the process.

Plant productivity, crop yield and soil health are directly related to each other. An organic carbon deficient soil cannot produce better crop and plant, and is considered as less fertile. Soil fertility can be enhanced/improved by improving the soil physical, chemical and biological properties.

Therefore, there is a need for an environmentally friendly additive capable of improving soil condition and soil property of compact or rigid soil by providing loosening effect on soil resulting in soil becoming less rigid and less compact to facilitate favorable soil conditions for plants which allow roots to penetrate the soil more efficiently.

Therefore, the present disclosure envisages a composition for improving soil condition which in turn promotes plant growth and that mitigates the aforestated drawbacks.

The present invention is directed to a composition or an agricultural composition to improve the soil fertility. In an embodiment, the composition includes 1% of water-retaining gel, 40% of beneficial bacteria like cellulose, lignin, pectin and lipids decomposer 40%, raw materials including liquid waste decompose and 2-10% of Jaggery. The composition decomposes plant roots and undecomposed materials thereby increasing the organic carbon as well all nutrient to the plant. The composition is capable of decomposing all biodegradable material in 22-30 days, wherein the process of decomposition is cold less emission of gases. In an another embodiment, the composition increases the organic carbon in decomposed material, Nutrient contents are high and also increase the organic carbon in the soil. In yet another embodiment, the semi liquid or gel form of the composition has more than 5 years shelf life which can survive in normal outside temperature. The composition of the present invention use as a soil conditioner in the field of agricultural crop cultivation.

In yet another embodiment of the present invention is a process for preparing an agricultural composition by adding 100 litres of water mixing with 1 kg of jaggery, beneficial bacteria and a considerable amount of raw materials including liquid waste decompose, and kept for 5 days in normal outside temperature to self-multiple. The beneficial bacteria including Cellulose, Lignin, pectin and lipids, the decomposer 40% by wt and Jaggery of 2-10% by wt.

The present invention is directed to a composition, which utilizes a particular combination of beneficial bacteria or microbes to decompose the majority of liquid waste decompose material and convert the same into water, carbon dioxide and a small amount of sediment.

In an example embodiment, using the appropriate beneficial bacteria results in decomposition of most of the liquid waste into water and carbon dioxide. In certain embodiments, the beneficial bacteria comprises from 1 to about 10 different strains of bacteria. In certain preferred embodiments, the beneficial bacteria comprises about two to four different strains of species. Additionally, the presently described compositions and process are not costly and eliminate that inefficiencies associated with incineration, dehydration or other mechanical means of eliminating organic waste.

The beneficial bacteria or microbes used in the compositions of the present invention may include species of bacillus, lactobacillus, burkholderia, actimomyces, yeast fungus, eumycetes, as well as combinations thereof. The bacteria is capable of breaking the single or double bond of the compound present in the soil. Further, the beneficial bacteria includes Harmon's and enzyme which help early germination of seeds and better root development.

The mixture is capable of decomposing the majority of food waste materials, including protein, starch, grease and cellulose; thus, one or more of the microbes of the mixture must be capable of decomposing long chain structures which are inherent in fats and starches of food waste. The choice of microbes to add to the mixture and the proportion in which they are added may depend upon the general chemical composition of the food waste intended to be decomposed. The particular mixture of microbes used in a mix may be altered to more efficiently decompose waste of a particular composition.

Additionally, when choosing microbes for the mixture, stability, vitality, adaptability, safety and resolvability of the microbes is also taken into consideration. In light of these criteria, strains such as streptomyces sp., cellulosinicrobium funkei, brucella sp., arthrobacter sp. and paenibacillus cookie may also be useful in the microbial mixture. The mixture of the invention may contain anywhere from 1 to 10 strains of bacillus, lactobacillus, actimomyces, fungus, Azotobacter, Azosprillium, Rhizobium, Nitrobacter, phosphates solubilizing bacteria, Potassium mobilising bacteria, Pseudomanus, Bacillus firmus, Bacillus niacini, Lysinibacillus fusiformis, Paenibacillus macquariensis, Bacillus simplex, Solibacillus silverstris, Bacillus aminovorans as well as combinations thereof.

In one embodiment of the present invention is a liquid waste decomposer which is a mother culture of beneficial microorganism. The product or composition is targeted farmers to set up their production unit in open field and further multiple the product in large scale throughout their life. In an embodiment the process of preparing the composition needs a vessel e.g. a plastic drum and jaggery to multiple in simple way by using 100 litres of water with 1 kg jaggery and liquid waste decompose. Further, it should be added and kept for 5 days to self-multiple. The product or composition will provide cheap solution to improve their soil in 6 months and also increase the fertiliser use efficiency, ultimately it will reduce 50% doses in all crops.

The product or composition is ideal to improve the soil fertility it's application as irrigation it decomposes plant roots, undecomposed material thereby increase the organic carbon as well all nutrient to the plant. Hence, the plant growth is good. It also improve the soil nutrient as the product contains microorganisms releases organic acid which break the single or double bond of the compound present in soil. Furthermore, the spray of the product also increase the photosynthesis of plant. The product or the composition release many Harmon's and enzyme which help early germination of seeds and better root development. The use of product or composition will increase the fertiliser use efficiency hence doses will be reduced by 50%. Further, the use of the product or composition will reduce the fixation by 50%,hence the doses will be reduced. Moreover, the composition improves the soil health it's physical and chemical conditions in 1 year in all types of soil. Furthermore, it generated more than 5 Lakhs earthworms in one year. The earthworms may be black, brown, red, keshariya etc. ultimately white surface earthworms which are the indicator of good soil. Moreover, it also increase the organic carbon, increase fertiliser use efficiency by 50% percent.

### EXAMPLE

Shelf Life—Solid Waste Decomposer v/s Liquid Waste Decomposer

The shelf life of both mother culture was evaluated. Both the mother culture were multiplied in medium every month containing 100 litres of water by adding 1 kg of jaggery.

In zero month, that is, January 2015 both the culture multiplied and after 7 days plate count was done showing the growth of the culture. The results were recorded every month until December, 2019 and the plate count repeated.

At 36th month, that is, in December 2017, solid mother culture has shown no growth in mass multiplication as well as on plate count while liquid waste decomposer mother culture shows the good growth in mass multiplication as well as on plate.

This shows that solid waste decomposer has only 36 month shelf life.

The experiment was continued with liquid waste decomposer up to 60 months, that is, December 2019 showing the excellent grow in mass multiplication as well as on plate.

The solid waste decomposer experiment was continued even after 36 months to confirm the survivability. It was observed that at 37th and 38th month it showed no growth which concludes that liquid waste decomposer has more than 5 years shelf life.

Further examples includes, the fertiliser like e.g. Urea plant get only 30-40% rest is loss. The phosphatic, potassium fertiliser fix in soil up to 80% only 20% is available for the plant.

Advantages:

1. Decompose all biodegradable material in 22-30 days.
2. Process of decomposition is cold less emission of gases.
3. Increase the organic carbon in decomposed material.
4. Nutrient contents are high
5. Increase the organic carbon in soil

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure described herein above has several technical advantages including, but not limited to, the realization of an additive, agricultural composition and kit-of-parts, additive is stable and aids in conditioning of the soil, improving soil properties, providing nourishment to plants and thereby improving plant growth and improvement of crop yield.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. An agricultural composition to improve the soil fertility, comprising: 1% of water-retaining gel, 40% of beneficial bacteria like cellulose, lignin, pectin and lipids decomposer 40%, raw materials including liquid waste decompose and 2-10% of Jaggery, wherein the composition decomposes plant roots and undecomposed materials thereby increasing the organic carbon as well all nutrient to the plant.

2. The agricultural composition as claimed in claim 1, wherein the bacteria comprises bacillus, lactobacillus, bactimomyces, fungus, Bacillus firmus, Bacillus niacini, Lysinibacillus fusiformis, Paenibacillus macquariensis, Bacillus simplex, Solibacillus silverstris, Bacillus aminovorans which are capable of breaking the single or double bond of the compound present in the soil.

3. The agricultural composition as claimed in claim 1, wherein the gel agent is selected from the group consisting of Nitrogen fixing, Phosphates solubilizing bacteria, potassium mobilising, cellulose, lignin decomposer.

4. The agricultural composition as claimed in claim 1, wherein the beneficial bacteria includes Harmon's and enzyme which help early germination of seeds and better root development.

5. The agricultural composition as claimed in claim 1 decompose all biodegradable material in 22-30 days, wherein the process of decomposition is cold less emission of gases.

6. The agricultural composition as claimed in claim 1 increase the organic carbon in decomposed material, Nutrient contents are high and also increase the organic carbon in the soil.

7. The agricultural composition as claimed in claim 1, wherein the semi liquid or gel form of the composition has more than 5 years shelf life which can survive in normal outside temperature.

8. The agricultural composition according to any one of the above is use as a soil conditioner in the field of agricultural crop cultivation.

9. A process for preparing an agricultural composition, comprising:
adding 100 litres of water mixing with 1 kg of jaggery, beneficial bacteria and a considerable amount of raw materials including liquid waste decompose, and kept for 5 days in normal outside temperature to self-multiple.

10. The process as claimed in claim 9, wherein beneficial bacteria including Cellulose, Lignin, pectin and lipids, the decomposer 40% by wt and Jaggery of 2-10% by wt.
